(19) United States
(12) Patent Application Publication
(10) Pub. No.: US 2025/0158429 A1
(43) Pub. Date: May 15, 2025

(54) ENERGY STORAGE SYSTEM, CONTROL METHOD THEREOF, DEVICE, ELECTRONIC DEVICE, AND STORAGE MEDIUM

(71) Applicant: ALPHA ESS CO., LTD., Nantong, Jiangsu (CN)

(72) Inventors: Xiuli SI, Nantong (CN); Xiongjiang LIU, Nantong (CN); Songhua ZHU, Nantong (CN); Liyan SUN, Nantong (CN); Siwei JIANG, Nantong (CN); Haiyan ZHANG, Nantong (CN)

(73) Assignee: ALPHA ESS CO., LTD., Nantong, Jiangsu (CN)

(21) Appl. No.: 18/723,079

(22) PCT Filed: Sep. 23, 2022
(86) PCT No.: PCT/CN2022/120876

§ 371 Date: Jun. 21, 2024

(30) Foreign Application Priority Data
Jul. 8, 2022 (CN) 202210806591.6

(51) Int. Cl. H02J 7/00; H01M 10/42

(52) U.S. Cl. CPC H02J 7/0031; H01M 10/425; H02J 7/0013; H01M 2010/4278

(57) ABSTRACT

The present application provides an energy storage system, control method thereof, device, electronic equipment, and storage medium. The energy storage system comprises multiple interconnected battery devices and a communication network, where a battery device comprises a positive electrode and a negative electrode, and a battery device comprises a storage battery, a controller, and first and second switch modules; a positive pole of the storage battery is connected to a first terminal of the first switch module, the positive electrode and a first terminal of the second switch module are connected to a second terminal of the first switch module, and a second terminal of the second switch module is connected to a negative pole of the storage battery. The multiple battery devices can simultaneously perform disconnection and connection operations.

### CROSS-REFERENCE TO RELATED APPLICATION

The application claims priority from Chinese Patent Application No. 202210806591.6, filed Jul. 8, 2022, entitled “Energy Storage System, Control Method Thereof, Device, Electronic Device, and Storage Medium”, all of which are incorporated herein by reference in their entirety.

### TECHNICAL FIELD

The present application relates to the field of energy storage technology, and more particularly to an energy storage system, control method thereof, device, electronic device, and storage medium.

### BACKGROUND

With the proliferation of new energy vehicles and the implementation of goals such as “carbon neutrality” and “carbon peak”, the overall energy structure of society is shifting towards electrical energy. Energy storage systems are required in new energy vehicles, and in solar power generation and wind power generation.

In practice, energy storage systems usually consist of multiple battery devices connected with each other. To enhance the stability of energy storage systems, additional battery devices are often included, thus providing some redundancy. If a single battery device fails due to overvoltage, undervoltage, or overheating, causing the battery device to cease functioning, the entire series circuit is affected and fails to function. The situation mentioned above necessitates bypassing the malfunctioning battery devices and integrating the remaining ones into the circuit. Additionally, during charging and discharging, some battery devices may need to be bypassed, and others connected into the series circuit. It is understood that if the bypass operation and connection operation are not synchronized during use, voltage fluctuations at the output terminal of the energy storage system can occur, potentially causing the system to crash and become inoperable.

### SUMMARY

An objective of the present application is to provide an energy storage system, control method thereof, device, electronic device, and storage medium.

To achieve one of the above objectives, an embodiment of the present application provides an energy storage system which comprises: M battery devices interconnected and a communication network, where a battery device comprises a positive electrode and a negative electrode, and a battery device comprises a storage battery, a controller, a first switch module, and a second switch module; and M controllers are configured to communicate with each other via the communication network, where M is a natural number, M≥2; a positive pole of the storage battery is connected to a first terminal of the first switch module, the positive electrode and a first terminal of the second switch module are both connected to a second terminal of the first switch module, and a second terminal of the second switch module is connected to a negative pole of the storage battery; the controller is configured to control connection and disconnection between the first terminal of the first switch module and the second terminal of the first switch module and control connection and disconnection between the first terminal of the second switch module and the second terminal of the second switch module.

As a further improvement of an embodiment of the present application, the first switch module and the second switch module are switching transistors, in the first switch module and the second switch module, the first terminal is one of a collector and an emitter of a switching transistor, the second terminal is another of the collector and the emitter of the switching transistor; the controller is connected to a base of a switching transistor of the first switch module and also to a base of a switching transistor of the second switch module.

An embodiment of the present application provides a control method for a controller. which comprises; synchronizing in time with another M−1 controllers based on a communication network; acquiring first status information of a storage battery corresponding to a current controller and sending the first status information to another M−1 controllers via the communication network, and receiving second status information sent by another M-1 controllers; selecting a first main controller among M controllers based on a first predetermined algorithm, the first status information, and M−1 sets of second status information, and arranging the M controllers into a sorted queue; selecting N target controllers from the sorted queue from an end of the sorted queue towards a front of the sorted queue, and generating operation commands for the N target controllers, which are same for all N target controllers, where the operation commands are configured to characterize a bypass operation or a connection operation to the storage battery, where N is a natural number, N≤M; generating an operation time, and sending corresponding operation commands and the operation time to the N target controllers respectively when the current controller is the first main controller, where the operation time is later than a current time; executing operations as follows at the received operation time when the operation command and operation time are received: controlling the first switch module to be in a disconnected state and the second switch module to be in a connected state when the operation command indicates a bypass operation; controlling the first switch module to be in a connected state and the second switch module to be in a disconnected state when the operation command indicates a connection operation.

As a further improvement of an embodiment of the present application, a step of “sending corresponding operation commands and the operation time to the N target controllers respectively” specifically includes: sending corresponding operation commands and the operation time to all M controllers respectively; where operation commands for remaining M−N controllers is configured to indicate a connection operation when operation commands for the N target controllers is configured to indicate a bypass operation, and operation commands for remaining M−N controllers is configured to indicate a bypass operation when operation commands for the N target controllers is configured to indicate a connection operation.

As a further improvement of an embodiment of the present application. the first status information and the second status information include a State of Charge (SOC) value of the storage battery; a step of “selecting a first main controller among M controllers based on a first predetermined algorithm, the first status information, and M−1 sets of second status information. and arranging the M controllers into a sorted queue” specifically includes: selecting a first main controller among M controllers based on a first predetermined algorithm and SOC values of M controllers; arranging the M controllers into a sorted queue from a lowest SOC value to a highest SOC value when a corresponding storage battery is in a charging state; arranging the M controllers into a sorted queue from a highest SOC value to a lowest SOC value when a corresponding storage battery is in a discharging state; a step of “generating operation commands for the N target controllers, which are same for all N target controllers” specifically includes: generating operation commands indicating a bypass operation for the N target controllers.

As a further improvement of an embodiment of the present application, the first status information and the second status information include a health value of the storage battery, where a higher health value indicates a better condition of the storage battery; a step of “selecting a first main controller among M controllers based on a first predetermined algorithm, the first status information, and M−1 sets of second status information, and arranging the M controllers into a sorted queue” specifically includes: selecting a first main controller among M controllers based on a first predetermined algorithm and health values of M controllers; arranging the M controllers into a sorted queue from a highest health value to a lowest health value; a step of “generating operation commands for the N target controllers, which are same for all N target controllers” specifically includes: generating operation commands indicating a bypass operation for the N target controllers.

As a further improvement of an embodiment of the present application, a step of “synchronizing in time with another M−1 controllers based on a communication network” specifically includes: selecting a second main controller among another M−1 controllers through a second predetermined algorithm; sending a first message to the second main controller via a communication network by a current controller, with the first message including a first timestamp T1 of when the first message leaves the current controller; receiving a second message returned by the second main controller, with the second message including a second timestamp T2 of when the first message reaches the second main controller and a third timestamp T3 of when the second message leaves the second main controller, and obtaining a fourth timestamp T4 of when the current controller receives the second message; adjusting time of the current controller based on a time difference between the current controller and the second main controller which is calculated as ((T2−T1)+(T3−T4))/2.

As a further improvement of an embodiment of the present application, a configuration voltage of the energy storage system is V; when operation commands for the N target controllers is configured to indicate a bypass operation, a total voltage of storage batteries corresponding to remaining M−N controllers is Sum1, where |Sum1−V|≤error threshold; when operation commands for the N target controllers is configured to indicate a connection operation, a total voltage of storage batteries corresponding to the N target controllers is Sum2, where |Sum2−V|≤error threshold; where the error threshold>0.

An embodiment of the present application provides a control device for a controller, which comprises following modules: a time synchronization module, configured to synchronize in time with another M−1 controllers based on a communication network; a selection module, configured to acquire first status information of a storage battery corresponding to a current controller and send the first status information to another M−1 controllers via the communication network, and receive second status information sent by another M−1 controllers; select a first main controller among M controllers based on a first predetermined algorithm, the first status information, and M−1 sets of second status information, and arrange the M controllers into a sorted queue; select N target controllers from the sorted queue from an end of the sorted queue towards a front of the sorted queue, and generate operation commands for the N target controllers, which are same for all N target controllers, where the operation commands are configured to characterize a bypass operation or a connection operation to the storage battery, where N is a natural number, N≤M; a command sending module, configured to generate an operation time and send corresponding operation commands and the operation time to the N target controllers respectively when the current controller is the first main controller, where the operation time is later than a current time; a command execution module, configured to execute operations as follows at the received operation time when the operation command and operation time are received: control the first switch module to be in a disconnected state and the second switch module to be in a connected state when the operation command indicates a bypass operation; control the first switch module to be in a connected state and the second switch module to be in a disconnected state when the operation command indicates a connection operation.

An embodiment of the present application provides an electronic device, which comprises: a memory configured to store executable instructions; a processor configured to execute the executable instructions stored in the memory to implement an aforementioned control method.

An embodiment of the present application provides a storage medium, storing executable instructions, which when executed by a processor, implement an aforementioned control method.

Compared with the prior art, the present application enhances technical effectiveness by providing an energy storage system, control method thereof, devices, electronic equipment, and storage media. The energy storage system comprises multiple interconnected battery devices and a communication network. A battery device includes a positive and negative electrode. A battery device includes a storage battery, a controller, a first switch module and a second switch module. The controllers configured to communicate with each other via the communication network. A positive pole of the storage battery is connected to a first terminal of the first switch module, the positive electrode and a first terminal of the second switch module are both connected to a second terminal of the first switch module, and a second terminal of the second switch module is connected to a negative pole of the storage battery. A controller is configured to control connection and disconnection between the first terminal of the first switch module and the second terminal of the first switch module and control connection and disconnection between the first terminal of the second switch module and the second terminal of the second switch module. The multiple battery devices are configured to facilitate simultaneous disconnection operation and connection operation.

### BRIEF DESCRIPTION OF THE DRAWINGS

FIG. 1 shows a schematic diagram of a structure of an energy storage system in an embodiment of the present application;

FIG. 2 shows a flowchart of a control method in an embodiment of the present application.

### DETAILED DESCRIPTION

The following description of various embodiments of the present application is provided in conjunction with accompanying drawings. Embodiments are illustrative and do not limit the present application. Those skilled in the art can make structural, methodological, or functional changes based on these embodiments, which are included within the protective scope of the present application.

The terms such as “above,” “upper,” “below,” “lower,” etc., used in the present application describe the spatial relative positions of one unit or feature relative to another as shown in the drawings, for ease of explanation. The terms of spatial relative positions are intended to include orientations of the device during use or operation beyond those shown in the diagrams. For instance, if the device in the diagram is flipped over, a unit described as being “below” or “under” another unit or feature would then be “above” it. Therefore, the exemplary term “below” can encompass both above and below directions. The device can be oriented differently (rotated 90 degrees or other orientations), and the spatial descriptions used herein are interpreted accordingly.

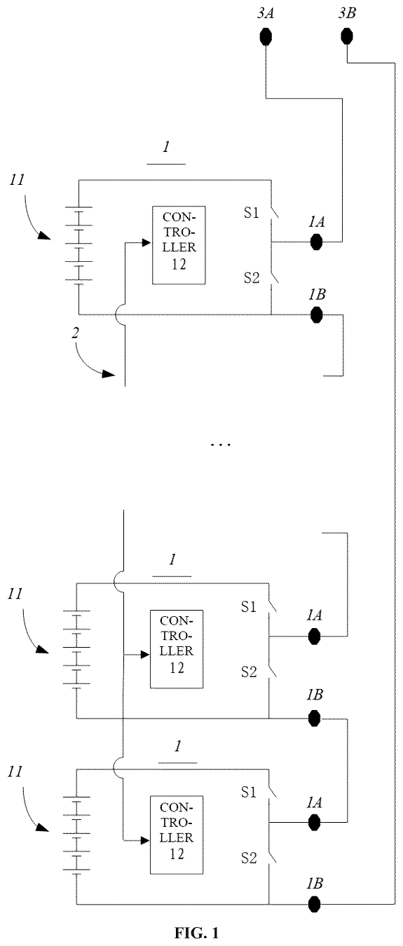

Embodiment 1 of the present application provides an energy storage system, as shown in FIG. 1, comprising:

M battery devices 1 interconnected and a communication network 2. A battery device 1 includes a positive electrode 1A and a negative electrode 1B. A battery device 1 includes a storage battery 11, a controller 12, a first switch module S1, and a second switch module S2. M controllers 12 are configured to communicate with each other via the communication network 2. M is a natural number. M≥2. The storage battery 11 may include multiple battery cells connected in series or parallel, forming the storage battery 11. The storage battery could be of types such as nickel-metal hydride, nickel-cadmium, or lithium batteries. The controller 12 could be a microcontroller, etc. The communication network 2 could be an Ethernet, fiber-optic network, or CAN (Controller Area Network), etc. It is understood that the number of battery devices 1 in the energy storage system can be increased or decreased based on actual needs.

Each battery device 1 includes a controller 12. Each battery device 1 can independently control storage battery 11 therein. The energy storage system is a distributed control system. It is understood that, in the energy storage system, when a battery device 1 is damaged, simply bypass the damaged battery device 1 and the energy storage system can still function normally.

To facilitate the differentiation and management of different controllers 12, different controllers 12 can be assigned different names. Each controller 12 can be assigned a unique identifier, which can also be considered as an identifier for the battery device 1. Additionally, each controller 12 is equipped with a communication module.

A positive electrode of the storage battery 11 is connected (e.g., electrically connected) to a first terminal of the first switch module S1. Both the positive electrode 1A and a first terminal of the second switch module S2 are connected (e.g., electrically connected) to a second terminal of the first switch module S1. A second terminal of the second switch module S2 is connected (e.g., electrically connected) to a negative electrode of the storage battery 11.

The controller 12 is configured to control connection and disconnection between the first terminal of the first switch module SI and the second terminal of the first switch module S1. The controller 12 is configured to control connection and disconnection between the first terminal of the second module S2 and the second terminal of the second switch module S2.

As shown in FIG. 1, within a battery device 1, when the first switch module S1 is in a connected state and the second switch module S2 is in a disconnected state, the battery device 1 is connected to the energy storage system. When the first switch module S1 is in a disconnected state and the second switch module S2 is in a connected state, the battery device 1 is in a bypass state, meaning the battery device 1 is not connected to the energy storage system.

As shown in FIG. 1, the M interconnected battery devices 1 are connected in series. For two adjacent battery devices 1, a positive electrode 1A of one battery device 1 is connected (e.g., electrically connected) to a negative electrode 1B of another battery device 1. Moreover, in this battery system, there are also a positive output terminal 3A and a negative output terminal 3B.

In an embodiment, the first switch module and the second switch module are switching transistors. In the first switch module and the second switch module, the first terminal is one of a collector or an emitter of a switching transistor, while the second terminal is another of the collector and the emitter of the switching transistor. The controller 12 is connected (e.g., electrically connected) to a base of a switching transistor of the first switch module S1, as well as to a base of a switching transistor of the second switch module S2. The controller 12 can control a voltage at a base of a switching transistor of the first switch module and a voltage at a base of a switching transistor of the second switch module, thereby controlling the connection and disconnection between the collector and the emitter of switching transistors of the first switch module and the second switch module.

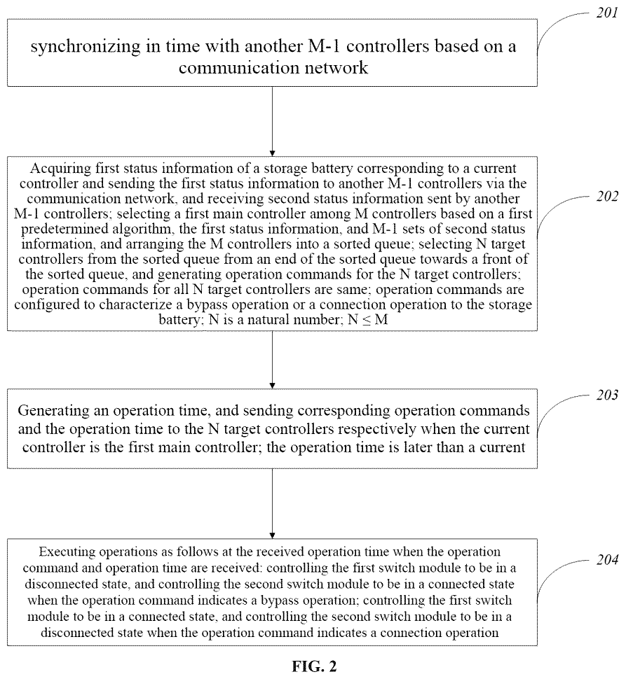

Embodiment 2 of the present application provides a control method. The control method can be implemented in the controller 12 in the Embodiment 1. The controller 12 can execute the control method at a preset interval, such as every 60 seconds, etc. Additionally, the controller 12 continuously monitors status values of corresponding storage battery 11, such as voltage, temperature, State of Charge (SOC), highest single cell voltage, lowest single cell voltage, and current, etc. When the status values are outside a predetermined range, the controller 12 can issue execution commands to any other controllers 12, thereby each controller 12 can perform the control method. In the energy storage system, there are M controllers 12, each configured to execute the control method. As shown in FIG. 2, the method includes the following steps:

Step 201: synchronizing in time with another M−1 controllers 12 based on a communication network 2. In an energy storage system, each of M controllers 12 has its independent system clock. To eliminate time discrepancies among the controllers 12, time synchronization across all M controllers 12 is required.

Step 202: Acquiring first status information of a storage battery 11 corresponding to a current controller and sending the first status information to another M−1 controllers 12 via the communication network 2, and receiving second status information sent by another M−1 controllers 12. Selecting a first main controller among M controllers 12 based on a first predetermined algorithm, the first status information, and M−1 sets of second status information, and arranging the M controllers 12 into a sorted queue. Selecting N target controllers from the sorted queue from an end of the sorted queue towards a front of the sorted queue, and generating operation commands for the N target controllers. Operation commands for all N target controllers are same. Operation commands are configured to characterize a bypass operation or a connection operation to the storage battery 11. N is a natural number. N≤M.

In practice, a controller which executes the control method can be referred to as “the current controller.” The first status information and the second status information may include a voltage of the storage battery 11, a current of the storage battery 11, and a temperature of the storage battery 11. A step of “arranging the M controllers 12 into a sorted queue based on a first predetermined algorithm, the first status information, and M−1 sets of second status information” can be understood as: processing status information of each controller 12 using a first predetermined algorithm, resulting in M scores corresponding to the M controllers 12 one-to-one; arranging the scores in an ascending order or a descending order to form a sorted queue. From the sorted queue, N controllers are selected as N target controllers for operation. For instance, based on the first status information and the second status information, scores for each storage battery 11 can be determined according to quality of each storage battery 11 (higher quality results in higher scores), and the M storage batteries 11 could be arranged from a highest score to a lowest score. Subsequently, N controllers are selected for bypass operations, and remaining M−N controllers for connection operations. Moreover, during charging, based on the first status information and the second status information, each storage battery 11 can be scored based on its remaining charge (more remaining charge results in higher scores), and the M storage batteries 11 arranged from a highest score to a lowest score. N controllers are selected for connection operations, and remaining M−N for bypass operations according to the arrangement. During discharging, based on the first status information and the second status information, each storage battery 11 can be scored based on its remaining charge (more remaining charge results in higher scores), and the M storage batteries 11 arranged from a lowest score to a highest score. N controllers are selected for connection operations, and remaining M−N for bypass operations according to the arrangement.

Step 203: Generating an operation time, and sending corresponding operation commands and the operation time to the N target controllers respectively when the current controller is the first main controller. The operation time is later than a current time. The operation time for each controller is same. It is understood that when the current controller is the first main controller, it also sends an operation command and the operation time to itself. In practice, to prevent data errors while sending corresponding operation commands and the operation time to the N target controllers via communication network 2, a checksum, such as a CRC (Cyclic Redundancy Check) code, can be added to the data packet.

Step 204: Executing operations as follows at the received operation time when the operation command and operation time are received: controlling the first switch module S1 to be in a disconnected state, and controlling the second switch module S2 to be in a connected state when the operation command indicates a bypass operation; controlling the first switch module S1 to be in a connected state, and controlling the second switch module S2 to be in a disconnected state when the operation command indicates a connection operation. In practice, a timer can be set, which times out at the operation time, allowing for the immediate execution of the “operations as follows” mentioned above.

Since time synchronization has been previously implemented, each controller can execute the operation command at a same time, allowing bypass operation and connection operation to occur synchronously. The time synchronization can effectively prevent sudden voltage changes at the output terminal of the energy storage system, reducing the possibility of system downtime.

When the first switch module S1 is in a disconnected state and a step of “controlling the first switch module S1 to be in a disconnected state” needs to be implemented, no action is required. When the first switch module S1 is in a disconnected state and a step of “controlling the first switch module S1 to be in a connected state” needs to be implemented, the first switch module S1 needs to be switched to a connected state. When the first switch module S1 is in a connected state and a step of “controlling the first switch module S1 to be in a connected state” needs to be implemented, no action is required. When the first switch module S1 is in a connected state and a step of “controlling the first switch module S1 to be in a disconnected state” needs to be implemented, the first switch module S1 needs to be switched to a disconnected state. Similarly, those skilled in the art can obtain technical solutions for the second switch module S2.

In the long-term experiments conducted by the inventors, it was found that implementing any of the control methods mentioned above, time discrepancy during the execution of connection operation or bypass operation by different controllers is within 0.1 ms to 10 ms, which effectively prevents sudden voltage changes at the output terminal of the energy storage system, and reduces possibility of system downtime.

In an embodiment, a step of “sending corresponding operation commands and operation time to the N target controllers respectively” specifically includes: sending corresponding operation commands and the operation time to all M controllers respectively. Operation commands for remaining M−N controllers is configured to indicate a connection operation when operation commands for the N target controllers is configured to indicate a bypass operation. Operation commands for remaining M−N controllers is configured to indicate a bypass operation when operation commands for the N target controllers is configured to indicate a connection operation. In practice, the N target controllers and the remaining M−N controllers are configured to perform opposite operations.

In an embodiment, the first status information and the second status information include a State of Charge (SOC) value of the storage battery 11.

A step of “selecting a first main controller among M controllers 12 based on a first predetermined algorithm, the first status information, and M−1 sets of second status information, and arranging the M controllers 12 into a sorted queue” specifically includes: selecting a first main controller among M controllers 12 based on a first predetermined algorithm and SOC values of M controllers; arranging the M controllers 12 in a sorted queue from a lowest SOC value to a highest SOC value when a corresponding storage battery is in a charging state; arranging the M controllers 12 in a sorted queue from a highest SOC value to a lowest SOC value when a corresponding storage battery is in a discharging state.

During charging, the M controllers 12 are sorted in ascending order based on the SOC values to obtain a sorted queue, allowing storage batteries 11 with higher SOC values to be bypassed. During discharging, storage batteries 11 with lower SOC values need to be bypassed. As shown in FIG. 1, when a current flows from the positive electrode 1A to the negative electrode 1B, the energy storage system is in a charging state, and the storage battery 11 is in a “charging” state (even though the storage battery 11 may be in a bypass state, it does not preclude the storage battery 11 from being considered as being in a charging state based on the state of the energy storage system). As shown in FIG. 1, when a current flows from the negative electrode 1B to the positive electrode 1A, the energy storage system is in a discharging state, and the storage battery 11 is in a “discharging” state (even though the storage battery 11 may be in a bypass state, it does not preclude the storage battery 11 from being considered as being in a charging state based on the state of the energy storage system). Therefore, each battery device 1 could be equipped with a detector to determine whether a current is flowing from the positive electrode 1A to the negative electrode 1B or from the negative electrode 1B to the positive electrode 1A, thereby determining whether the storage battery 11 is in a charging state or in a discharging state.

A step of “generating operation commands for the N target controllers, which are same for all N target controllers” specifically includes: generating operation commands indicating a bypass operation for the N target controllers.

In an embodiment, the first status information and the second status information include a health value of the storage battery 11, where a higher health value indicates a better condition of the storage battery 11. A step of “selecting a first main controller among M controllers 12 based on a first predetermined algorithm, the first status information and M−1 sets of second status information, and arranging the M controllers 12 into a sorted queue” specifically includes: selecting a first main controller among M controllers 12 based on a first predetermined algorithm and health values of M controllers; arranging the M controllers 12 into a sorted queue from a highest health value to a lowest health value.

A step of “generating operation commands for the N target controllers, which are same for all N target controllers” specifically includes: generating operation commands indicating a bypass operation for the N target controllers.

In practice, it is necessary to bypass storage batteries 11 with lower health values. Initially, multiple attributes of the storage battery 11, such as voltage and temperature, etc., are obtained. Each attribute is then scored, with attributes indicating better health of the storage battery 11 determined higher scores, and attributes indicating poorer health of the storage battery 11 determined lower scores. The attribute scores are summed to determine the health value. Optionally, different attributes can be weighted differently. Maximum scores and minimum scores for different attributes are equal, meaning the attributes share a same scoring range.

In an embodiment, a step of “synchronizing in time with another M−1 controllers 12 based on a communication network 2” includes:

Step 1: Selecting a second main controller among another M−1 controllers 12 through a second predetermined algorithm. The second predetermined algorithm can be tailored to specific needs. For instance, all M controllers might send their status information over communication network 2, allowing each controller 12 to access status information of all M controllers 12 and apply a same second predetermined algorithm to determine the second main controller. Additionally, the second main controller can be directly programmed into each controller 12.

Step 2: Sending a first message to the second main controller via a communication network 2 by a current controller, with the first message including a first timestamp T1 of when the first message leaves the current controller.

Step 3: Receiving a second message returned by the second main controller, with the second message including a second timestamp T2 of when the first message reaches the second main controller and a third timestamp T3 of when the second message leaves the second main controller. Obtaining a fourth timestamp T4 of when the current controller receives the second message.

Step 4: Adjusting time of the current controller based on a time difference between the current controller and the second main controller which is calculated as ((T2−T1)+(T3−T4))/2.

It is understood that sending the first message and the second message between the current controller and the second main controller also consumes time spent T, with T2−T1 including both the time spent T and the time difference, and T3−T4 including the time spent (e.g., −1*T) and the time difference, thus the time difference is ((T2−T1)+(T3−T4))/2.

Optionally, to enhance the integrity of the first message and the second message, a checksum, such as a CRC (Cyclic Redundancy Check) code, can be added to the first message and the second message.

In an embodiment, a configuration voltage of the energy storage system is V. When operation commands for the N target controllers is configured to indicate a bypass operation, a total voltage of storage batteries 11 corresponding to remaining M−N controllers is Sum1, where −Sum1−V|≤error threshold. When operation commands for the N target controllers is configured to indicate a connection operation, a total voltage of storage batteries 11 corresponding to the N target controllers is Sum2, where |Sum2−V|≤error threshold. The error threshold being greater than 0). In practice, a configuration voltage is set to the energy storage system, and after some storage batteries 11 are bypassed, a voltage of remaining storage batteries 11 should meet a requirement of the configuration voltage. For instance, a difference between the voltage of the remaining storage batteries 11 and the configuration voltage should be within a narrow range of [−1*error threshold, error threshold].

Embodiment 3 of the present application provides a control device. The control device can be implemented in the controller in the Embodiment 1. The control device comprises following modules:

A time synchronization module, configured to synchronize in time with another M−1 controllers 12 based on a communication network 2;

A selection module, configured to acquire first status information of a storage battery 11 corresponding to a current controller and send the first status information to another M−1 controllers 12 via the communication network 2, and receive second status information sent by another M−1 controllers 12; select a first main controller among M controllers 12 based on a first predetermined algorithm, the first status information, and M−1 sets of second status information, and arrange the M controllers 12 into a sorted queue; select N target controllers from the sorted queue from an end of the sorted queue towards a front of the sorted queue, and generate operation commands for the N target controllers, which are same for all N target controllers, where the operation commands are configured to characterize a bypass operation or a connection operation to the storage battery 11, where N is a natural number, N≤M;

A command sending Module, configured to generate an operation time and send corresponding operation commands and the operation time to the N target controllers respectively when the current controller is the first main controller, where the operation time is later than a current time;

A command execution module, configured to execute operations as follows at the received operation time when the operation command and operation time are received: control the first switch module S1 to be in a disconnected state and the second switch module S2 to be in a connected state when the operation command indicates a bypass operation; control the first switch module S1 to be in a connected state and the second switch module S2 to be in a disconnected state when the operation command indicates a connection operation.

Embodiment 3 of the present application provides an electronic device, which comprises a memory configured to store executable instructions; and a processor configured to execute the executable instructions stored in the memory. The processor executes the stored executable instructions to implement a control method described in the Embodiment 1.

Embodiment 3 of the present application provides a storage medium that stores executable instructions. When the executable instruction executed by a processor, a control method described in Embodiment 1 is implemented.

It should be understood that although the specification describes embodiments, not every embodiment contains only one independent technical solution. The style of description is purely for clarity. Those skilled in the art should consider the specification as a whole; the technical solutions in various embodiments can be appropriately combined to form other embodiments that those skilled in the art can understand.

The detailed descriptions listed above are specific explanations of feasible embodiments of the present application and are not intended to limit the scope of the present application. Any equivalent implementations or changes made without departing from the spirit of the present application should also be included within the scope of the present application.

1. An energy storage system, which comprises:
M battery devices (1) interconnected and a communication network (2), where a battery device (1) comprises a positive electrode (1A) and a negative electrode (1B), and a battery device (1) comprises a storage battery (11), a controller (12), a first switch module (S1), and a second switch module (S2); and M controllers (12) are configured to communicate with each other via the communication network (2), where M is a natural number, M≥2;
a positive pole of the storage battery (11) is connected to a first terminal of the first switch module (S1), the positive electrode (1A) and a first terminal of the second switch module (S2) are both connected to a second terminal of the first switch module (S1), and a second terminal of the second switch module (S2) is connected to a negative pole of the storage battery (11);
the controller (12) is configured to control connection and disconnection between the first terminal of the first switch module (S1) and the second terminal of the first switch module (S1) and control connection and disconnection between the first terminal of the second switch module (S2) and the second terminal of the second switch module (S2).

2. The energy storage system according to claim 1, wherein:
the first switch module (S1) and the second switch module (S2) are switching transistors, in the first switch module (S1) and the second switch module (S2), the first terminal is one of a collector and an emitter of a switching transistor, the second terminal is another of the collector and the emitter of the switching transistor;
the controller (12) is connected to a base of a switching transistor of the first switch module (S1) and also to a base of a switching transistor of the second switch module (S2).

3. A control method for a controller of an energy storage system according to claim 1, which comprises:
synchronizing in time with another M−1 controllers (12) based on a communication network (2);
acquiring first status information of a storage battery (11) corresponding to a current controller and sending the first status information to another M−1 controllers (12) via the communication network (2), and receiving second status information sent by another M−1 controllers (12); selecting a first main controller among M controllers (12) based on a first predetermined algorithm, the first status information, and M−1 sets of second status information, and arranging the M controllers (12) into a sorted queue; selecting N target controllers from the sorted queue from an end of the sorted queue towards a front of the sorted queue, and generating operation commands for the N target controllers, which are same for all N target controllers, where the operation commands are configured to characterize a bypass operation or a connection operation to the storage battery (11), where N is a natural number, N≤M;
generating an operation time, and sending corresponding operation commands and the operation time to the N target controllers respectively when the current controller is the first main controller, where the operation time is later than a current time;
executing operations as follows at the received operation time when the operation command and operation time are received: controlling the first switch module (S1) to be in a disconnected state and the second switch module (S2) to be in a connected state when the operation command indicates a bypass operation, controlling the first switch module (S1) to be in a connected state and the second switch module (S2) to be in a disconnected state when the operation command indicates a connection operation.

4. The control method according to claim 3, wherein a step of “sending corresponding operation commands and the operation time to the N target controllers respectively” specifically includes:
sending corresponding operation commands and the operation time to all M controllers respectively; where operation commands for remaining M−N controllers is configured to indicate a connection operation when the operation commands for the N target controllers is configured to indicate a bypass operation; and operation commands the remaining M−N controllers is configured to indicate a bypass operation when operation commands for the N target controllers is configured to indicate a connection operation.

5. The control method according to claim 3, wherein:
the first status information and the second status information include an SOC value of the storage battery (11);
a step of “selecting a first main controller among M controllers (12) based on a first predetermined algorithm, the first status information, and M−1 sets of second status information, and arranging the M controllers (12) into a sorted queue” specifically includes: selecting a first main controller among M controllers (12) based on a first predetermined algorithm and SOC values of M controllers; arranging the M controllers (12) into a sorted queue from a lowest SOC value to a highest SOC value when a corresponding storage battery (11) is in a charging state; arranging the M controllers (12) into a sorted queue from a highest SOC value to a lowest SOC value when a corresponding storage battery (11) is in a discharging state;
a step of “generating operation commands for the N target controllers, which are same for all N target controllers” specifically includes: generating operation commands indicating a bypass operation for the N target controllers.

6. The control method according to claim 3, wherein:
the first status information and the second status information include a health value of the storage battery (11), where a higher health value indicates a better condition of the storage battery (11);
a step of “selecting a first main controller among M controllers (12) based on a first predetermined algorithm, the first status information, and M−1 sets of second status information, and arranging the M controllers (12) into a sorted queue” specifically includes: selecting a first main controller among M controllers (12) based on a first predetermined algorithm and health values of M controllers; arranging the M controllers (12) into a sorted queue from a highest health value to a lowest health value;
a step of “generating operation commands for the N target controllers, which are same for all N target controllers” specifically includes: generating operation commands indicating a bypass operation for the N target controllers.

7. The control method according to claim 3, wherein a step of “synchronizing in time with another M−1 controllers (12) based on a communication network (2)” specifically includes:
selecting a second main controller among another M−1 controllers (12) through a second predetermined algorithm;
sending a first message to the second main controller via a communication network (2) by a current controller, with the first message including a first timestamp T1 of when the first message leaves the current controller;
receiving a second message returned by the second main controller, with the second message including a second timestamp T2 of when the first message reaches the second main controller and a third timestamp T3 of when the second message leaves the second main controller, and obtaining a fourth timestamp T4 of when the current controller receives the second message,
adjusting time of the current controller based on a time difference between the current controller and the second main controller which is calculated as ((T2−T1)+(T3−T4))/2.

8. The control method according to claim 4, wherein:
a configuration voltage of the energy storage system is V;
when operation commands for the N target controllers is configured to indicate a bypass operation, a total voltage of storage batteries (11) corresponding to remaining M−N controllers is Sum1, where |Sum1−V|≤error threshold; when operation commands for the N target controllers is configured to indicate a connection operation, a total voltage of storage batteries (11) corresponding to the N target controllers is Sum2, where |Sum2−V|≤error threshold; where the error threshold>0.

9. A control device for a controller of an energy storage system according to claim 1, which comprises following modules:
a time synchronization module, configured to synchronize in time with another M−1 controllers (12) based on a communication network (2);
a selection module, configured to acquire first status information of a storage battery (11) corresponding to a current controller and send the first status information to another M−1 controllers (12) via the communication network (2), and receive second status information sent by another M−1 controllers (12); select a first main controller among M controllers (12) based on a first predetermined algorithm, the first status information, and M−1 sets of second status information, and arrange the M controllers (12) into a sorted queue; select N target controllers from the sorted queue from an end of the sorted queue towards a front of the sorted queue, and generate operation commands for the N target controllers, which are same for all N target controllers, where the operation commands are configured to characterize a bypass operation or a connection operation to the storage battery (11), where N is a natural number, N≤M;
a command sending module, configured to generate an operation time and send corresponding operation commands and the operation time to the N target controllers, respectively when the current controller is the first main controller, where the operation time is later than a current time;
a command execution module, configured to execute operations as follows at the received operation time when the operation command and operation time are received: control the first switch module (S1) to be in a disconnected state and the second switch module (S2) to be in a connected state when the operation command indicates a bypass operation; control the first switch module (S1) to be in a connected state and the second switch module (S2) to be in a disconnected state when the operation command indicates a connection operation.

10. An electronic device, which comprises:
a memory configured to store executable instructions;
a processor configured to execute the executable instructions stored in the memory to implement a control method according to claim 3.

11. A storage medium, storing executable instructions, which when executed by a processor, implement a control method according to claim 3.
